(19) United States
(12) Patent Application Publication
(10) Pub. No.: US 2008/0301046 A1
(43) Pub. Date: Dec. 4, 2008

(54) Methods and systems for making a payment and/or a donation via a network, such as the Internet, using a drag and drop user interface

(76) Inventors: Christian John Martinez, Novato, CA (US); Jean-Francois Boudier, San Francisco, CA (US)

Correspondence Address: Christian John Martinez, 1502 Buchanan Street, Novato, CA, 94947, US

(21) Appl. No.: 12/189,140

(22) Filed: Aug. 9, 2008

Related U.S. Application Data
(60) Provisional application No. 60/955,279, filed on Aug. 10, 2007.

(51) Int. Cl. G06Q 20/00

(52) U.S. Cl. 705/39

(57) ABSTRACT

The invention provides methods and systems that facilitate and expedite electronic transactions between a computer readable medium user (“Payor”), and a merchant or payee (“Payee”), including payment through the Internet. The invention allows the Payor to make a payment to a Payee of an exact desired amount using a drag and drop graphical user interface control, dragging from a graphical element displayed on the Payor terminal and dropping into a Payee's visual display on a website. The invention reduces the complexity and the time of the payment transaction, improving the user overall experience. The invention can be implemented for online commerce, for mobile payments, for small amount online payments, for online donations, or for payments using prepaid accounts. The invention can be implemented by an accounts issuer institution or by a funds and transactions managing entity.

### SUMMARY OF THE INVENTION

### Background of the Invention

This invention provides systems and methods within business and technology infrastructures and processes for facilitating electronic transactions for transferring money. Prior to this invention, there was no simple way to make online payments using a graphical user interface, which was particularly needed for payments on a mobile device such as a touchscreen equipped mobile phone, or micropayments or small payments (under $5). This invention reduces authorization processing time and cost for online and mobile transactions, and increases the efficacy of low value transactions.

Prior attempts to facilitate online payments failed to use the innovative drag and drop method for initiating a payment, which is the quickest and most intuitive method, particularly for micropayments, because of its seamless integration into the graphical display such as a web browser, or a mobile device. Security advances and economics have improved to the point where this invention is possible, unlike prior attempts in the late 1990's and early 2000's, and the independent database collects payments of virtually negligible worth until an aggregate amount is reached before disbursing funds directly or through an issuer, such as a bank or an online payment service such as Paypal.

In addition, prior attempts, whether token-based or account based models, failed to minimize the steps needed to complete a transaction to the extent that the claimed invention does. In fact, once initially logged in via passcode, the claimed invention completes the transaction when the user merely drags and drops and enters the exact amount desired (or vice versa). Further, the invention is universal as neither the Payor nor the Payee need to have pre-registered with the invention's database. An unregistered user, whether Payor or Payee will be referred to the invention's database or website upon payment or pending payment to enter appropriate information to either send or receive the payment. The invention is universal also because the funds can be dragged and dropped onto an email address as displayed on a website without any additional steps needed. The simple act of dragging and dropping as described herein will cause information relative to the Payor, Payee, and security confirmation sufficient to consummate the transaction.

This invention solves numerous technical and methodological issues and will facilitate payments for commerce or philanthropy.

### BRIEF DESCRIPTION OF THE DRAWINGS

Additional aspects of the claimed invention will become evident upon reviewing the non-limiting embodiments described in the specification and the claims taken in conjunction with the accompanying figures, wherein like reference numerals denote like elements, wherein:

FIG. 1 is a block diagram of exemplary components of one embodiment of the claimed invention, where the Payor Terminal and the Payee Terminal both include an embedded module dedicated to the invention;

FIG. 2 is a block diagram of exemplary components of one embodiment of the claimed invention, where the Payor Terminal includes an embedded module dedicated to the invention, and the Payee Terminal does not include an embedded module dedicated to the invention;

FIG. 3 is a block diagram of exemplary components of one embodiment of the claimed invention, where the Payor Terminal does not include an embedded module dedicated to the invention, and the Payee Terminal includes an embedded module dedicated to the invention;

FIG. 4 is a block diagram of exemplary components of one embodiment of the claimed invention, detailing exemplary database and application components included in the server dedicated to the claimed invention;

FIG. 5 is a block diagram of exemplary components of one embodiment of the claimed invention, detailing exemplary database and application components included in the server dedicated to the claimed invention, and where the server dedicated to the claimed invention is hosted or directly connected with the issuer server;

FIG. 6 is a flow diagram illustrating an exemplary embodiment of the method of the invention, where the Payor Terminal includes an embedded module dedicated to the invention;

FIG. 7 is a flow diagram illustrating an exemplary embodiment of the method of the invention, where the Payee Terminal does not include an embedded module dedicated to the invention;

FIG. 8 is a flow diagram illustrating an exemplary embodiment of the method of the invention, where the Payor Terminal does not include an embedded module dedicated to the invention;

FIG. 9 is a flow diagram illustrating an exemplary embodiment of the method of the invention, where the Payor Terminal includes an embedded module dedicated to the invention, and the method includes the steps of verifying the Payor as logged in and the Payor Terminal connection as secured;

FIG. 10 is a flow diagram illustrating an exemplary transaction method in accordance with an exemplary embodiment of the claimed invention;

FIG. 11 is a screen shot of an embodiment of a merchant payment window in accordance with the claimed invention, where the Payor Terminal includes an embedded module dedicated to the invention, displayed as a toolbar embedded within the Graphical User Interface, and the Payee Terminal includes a DragPay Payee Module;

FIG. 12 is a screen shot of an embodiment of a merchant payment window in accordance with the claimed invention, where the Payor Terminal includes an embedded module dedicated to the invention, displayed as a toolbar embedded within the Graphical User Interface, and the Payee Terminal does not include a DragPay Payee Module;

FIG. 13 is a screen shot of an embodiment of a merchant payment window in accordance with the claimed invention, where the Payor Terminal does not include an embedded module dedicated to the invention, and the Payee Terminal includes a DragPay Payee Module;

FIG. 14 is a screen shot of an embodiment of a confirmation window overlaying a merchant payment window in accordance with the claimed invention, where the Payor Terminal includes an embedded module dedicated to the invention, displayed as a toolbar embedded within the Graphical User Interface;

FIG. 15 is a screen shot of an embodiment of a confirmation window within the merchant online website in accordance with the claimed invention, where the Payor Terminal includes an embedded module dedicated to the invention, displayed as a toolbar embedded within the Graphical User Interface;

FIG. 16 is a screen shot of an embodiment of a confirmation window within the merchant online website in accordance with the claimed invention, where the Payor Terminal does not include an embedded module dedicated to the invention;

### DESCRIPTION OF POSSIBLE EMBODIMENTS

The detailed description of exemplary embodiments of the invention herein makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In general, the invention includes a unique system for facilitating online transactions including reduced authorization processes within commercial transaction processing systems. A “transaction,” as defined herein, includes, inter alia, any exchange or delivery of value, exchange or delivery of data, gifting of value or data, etc. The term “transaction” not only contemplates an exchange of goods or services for value from one party to another, but also the gifting of something from one party to another. Additionally, transaction codes or charge card numbers are account numbers that are used to facilitate any type of transaction.

While the system may contemplate upgrades or reconfigurations of existing processing systems, changes to Payor or Payee systems are not required by the claimed invention. For example, the present system may contemplate, but does not require: downloading of software modules; a digitally-based, non-physical commerce card; and certain embodiments may require the existing Payor to register for the online service. The transaction system herein described may be integrated into current electronic commerce processes with minimal or no changes to existing systems used by Payors or Payees.

The invention generally relates to transaction systems and methods where a Payor (also referred to as a “user”) pays a Payee through a payment manager (also referred to as an “issuer”).

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the claimed invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe, handheld device, mobile phone or the like. Payor computer can be in a home or business environment with access to a network. In an exemplary embodiment, access is through a network or the Internet through software, such as web-browsers.

As used herein, the term “network” shall include any electronic communications means which incorporates both hardware and software components of such. Communication among the parties in accordance with the claimed invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, Understanding DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The term “DragPay” is an exemplary name referring to the system embodying the claimed invention.

The claimed invention aims at facilitating transactions occurring between a Payor and a Payee via a network. The Payor is also referred within the present document as a “DragPay User”. The system managing the transactions is referred as “DragPay Server”.

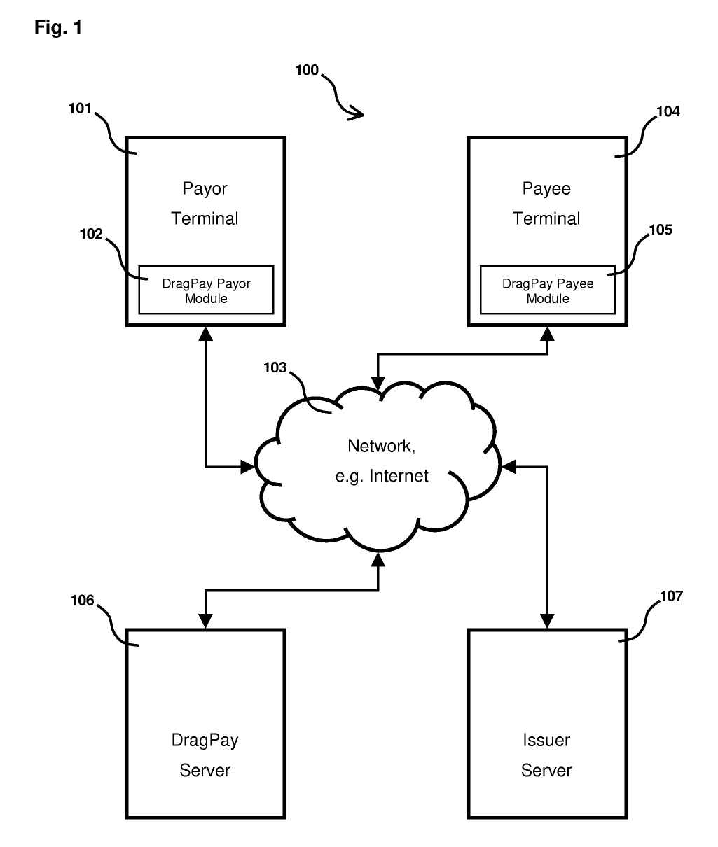

FIG. 1 depicts an overview of the components of an exemplary transaction system 100. A Payor Terminal 101 and Payee Terminal 104 communicate with each other and with an Issuer Server 107 and a DragPay Server 106 through a Network 103 such as the Internet.

The Payor Terminal 101 may be a computer readable medium such as, without limitations, a personal computer, a home electronics appliance, a handheld computer device, a mobile phone, or a device located within a actual merchant store; with a network connection and a Graphical User Interface. Such network connections may include, without limitations, any combination of modems, cable modems, wireless connections, digital subscriber lines, telephone lines, television cable lines having Internet connections, or other suitable network connections. Such Graphical User Interfaces include a combination of a Display System and a User Input System. Such Display Systems may include, without limitations, a computer monitor, a television screen, a LCD or TFT or plasma screen, a touch screen, or any display system used in a computer readable medium terminal. Such User Input System may include, without limitations, a computer mouse, a trackball device, a touchpad device, a joystick, a touch screen, or any input device which pointing feature can result in a drag and drop operation.

In one embodiment, the Network 103 is the Internet or another wide area network. However, other embodiments of the claimed invention can consider as a network any interconnection of computer readable mediums capable of sending and receiving information, such as, without limitation, telephone networks, wireless digital networks, serial cable networks, credit card or ATM networks, private networks, intranets, local area networks, and any collection of such networks and the Internet.

The Payee Terminal 104 may include any hardware and/or software system capable of receiving and transmitting information through the Network 103 and capable of receiving payments from a Payee using an Issuer Server 107. In one embodiment, the Payee Terminal 104 can be a merchant website, which goods and services are available for purchase through the Internet, and which can receive payments through a checkout system accepting multiple type of payments, such as, and without limitations, debit and credit card payments, personal checks payments, electronic cash, payments through dedicated systems such as Paypal, money order payments. In another embodiment of the claimed invention, the Payee Terminal 104 can be a website accepting donations, such as a non profit organization website, or a personal webpage in a social networking online service.

The Issuer Server 107 may include any hardware and/or software system capable of processing a transaction for the Payor through the Network 103, whether or not the Issuer company is issuing physical payment cards. Such transaction processing systems may include, without limitations, a credit card company system, a debit or other transaction related company system, a prepaid account system, a third party provider system under contract with financial institutions.

In one embodiment of the claimed invention, the Issuer Server 107 may be an online application server linked to a bank or financial institution allowing to process secure transactions over the Internet using a credit or debit card. In another exemplary embodiment of the claimed invention, the Issuer Server 107 may be an online server of a company, such as Paypal, able to manage payments through accounts managed by third party financial institutions. In another exemplary of the claimed invention, the Issuer Server 107 may be an online server managing prepaid funds and accounts accessible through the Network 103.

It should be apparent from the present description of the invention that a particular Payor can make a payment through several Issuers, and that different Payors may have different Issuers. The claimed invention is not limited to the use of a unique Issuer system.

The DragPay Server 106 is the system that implements the claimed invention. The DragPay Server 106 manages the information related to the Payor and/or the Payee accounts and information. The DragPay Server 106 interacts with the Payor Terminal 101, the Issuer Server 107 and the Payee Terminal 104 through the Network 103 in order to facilitate the processing of transactions between the Payor and the Payee.

In this exemplary embodiment 100 of the claimed invention, the Payor Terminal 101 includes a DragPay Payor Module 102. The DragPay Payor Module 102 is a software and/or hardware component that allows the Payor Terminal 101 to make a payment according to the claimed invention. In one embodiment of the invention, the DragPay Payor Module 102 can be a piece of software embedded into the Payor Terminal 101 Internet browser software, such as, and without limitations, a toolbar. This DragPay Payor Module 102 (e.g. toolbar) allows the Payor Terminal 101 to communicate with the DragPay Server 106 and go through the steps required to process the transaction. In another embodiment, the DragPay Payor Module 102 will allow the user to make a payment by using a Drag and Drop user interface by displaying an area, such as a virtual check icon or other graphical element, displayed by the Payor Terminal 101 and which the User can drag from to initiate a payment, and by monitoring the User Interface interactions in order to trigger the payment process when the Drag and Drop interaction is used to make a payment. The DragPay Payor Module 102 could also include additional functionalities such as, and without limitations, checking that the connections to the other components via the Network 103 is secured, affording the User to log in a registered account, affording the User to type in the amount and/or the currency that will be used for the payment.

In this exemplary embodiment 100 of the claimed invention, the Payee Terminal 104 includes a DragPay Payee Module 105. The DragPay Payee Module 105 is a software and/or hardware component that allows the Payee Terminal 104 to receive a payment according to the claimed invention. In one embodiment of the invention, the DragPay Payee Module 105 is a software component implemented within the Payee Terminal, such as a widget, that, on the front end, displays on the Payee website checkout area, displayed within the User Terminal 101 Internet browser software, a graphical component on which payments according to the claimed invention can be dropped during the Drag and Drop User Interface operation, and that, on the back end, communicates with the DragPay Server 106 and goes through the steps required to process the transaction.

This exemplary embodiment 100 of the claimed invention can be implemented for the purpose of general online commerce, for the purpose of payments restricted to micro or small amounts payments, for the purpose of payments via prepaid accounts, for the purpose of donations to individuals and/or organizations, or for any other purpose regarding payments over a network.

This exemplary embodiment 100 of the claimed invention can be implemented for the purpose of micro or small payments, when the payments are eventually received by the Payee once a fixed cumulative amount of payments is reached.

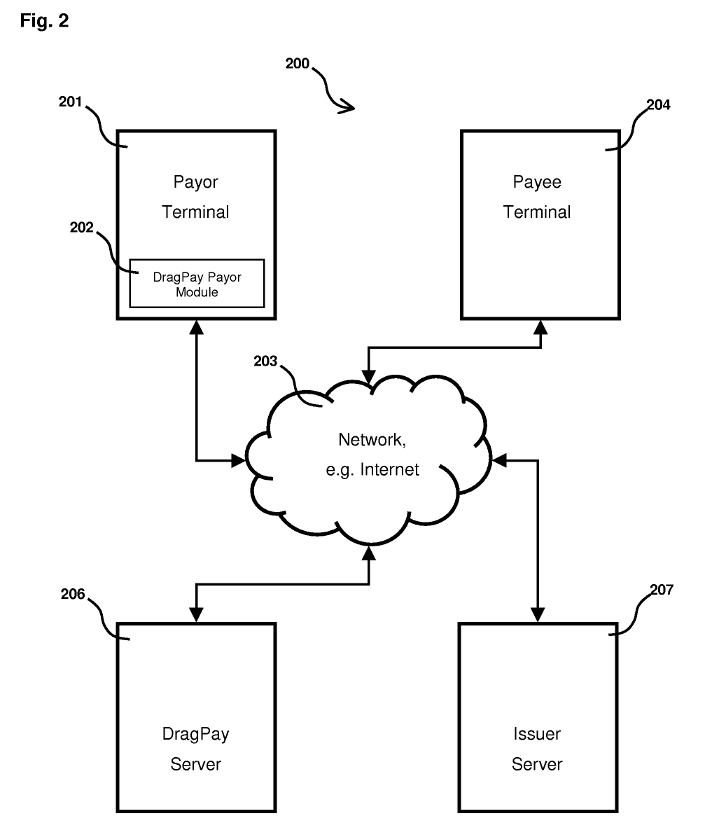

FIG. 2 depicts an overview of the components of an exemplary transaction system 200. A Payor Terminal 201 and Payee Terminal 204 communicate with each other and with an Issuer Server 207 and a DragPay Server 206 through a Network 203 such as the Internet.

The components 201 (Payor Terminal), 203 (Network), 204 (Payee Terminal), 206 (DragPay Server), 207 (Issuer Server), and 202 (DragPay Payor Module) are similar to respectively the components 101, 103, 104, 106, 107, 102 depicted in the overview 100 in FIG. 1 and described above.

In this exemplary embodiment of the claimed invention, the Payee Terminal 204 does not include a Payee DragPay module or any software and/or hardware component specifically related to the claimed invention.

This exemplary embodiment 200 of the claimed invention can be implemented when a Payor is willing to make a payment to a Payee that is not registered within the DragPay system. In this case, the Payor will use the Payor DragPay Module 202 to make a payment by using a Drag and Drop User Interface operation.

In another embodiment, the DragPay Payor Module 202 will allow the user to make a payment by using a Drag and Drop user interface, that is by displaying an area, such as a virtual check icon or other graphical element, displayed by the Payor Terminal 201 and which the User can drag from to initiate a payment, and by monitoring the User Interface interactions in order to trigger the transaction process when the Payor Drops on specific elements displayed on the Payee website, such as, and without limitations, an email address, an URL, or the whole display of the Payee website.

This exemplary embodiment 200 of the claimed invention can be implemented for the purpose of general online commerce, for the purpose of payments restricted to micro or small amounts payments, for the purpose of payments via prepaid accounts, for the purpose of donations to individuals and/or organizations, or for any other purpose regarding payments over a network.

This exemplary embodiment 200 of the claimed invention can be implemented for the purpose of micro or small payments, when the payments are eventually received by the Payee once a fixed cumulative amount of Payors payments is reached.

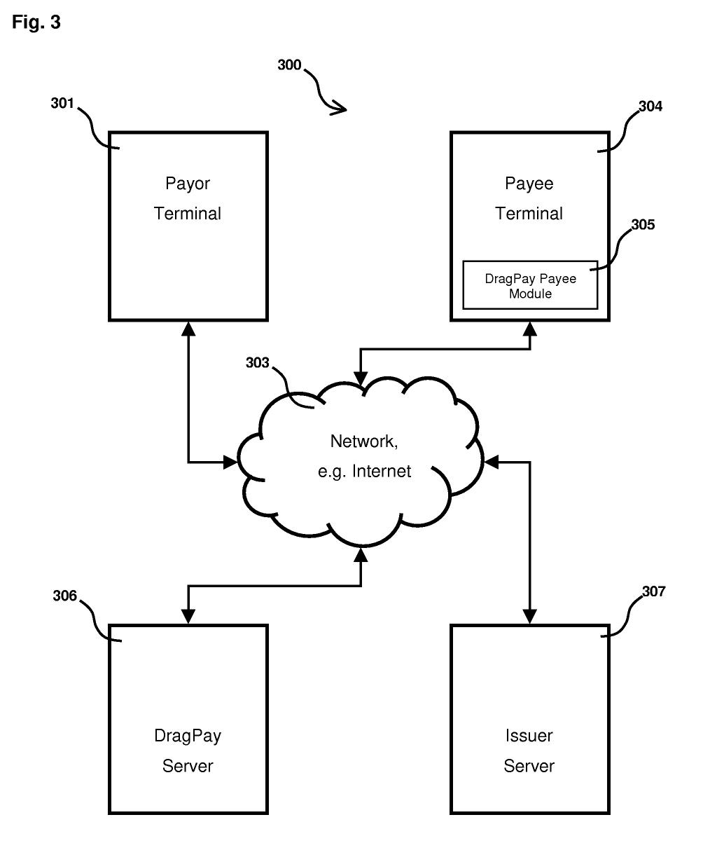

FIG. 3 depicts an overview of the components of an exemplary transaction system 300. A Payor Terminal 301 and Payee Terminal 304 communicate with each other and with an Issuer Server 307 and a DragPay Server 306 through a Network 303 such as the Internet.

The components 301 (Payor Terminal), 303 (Network), 304 (Payee Terminal), 306 (DragPay Server), 307 (Issuer Server), and 305 (DragPay Payee Module) are similar to respectively the components 101, 103, 104, 106, 107, 105 depicted in the overview 100 in FIG. 1 and described above.

In this exemplary embodiment of the claimed invention, the Payor Terminal 301 does not include a Payee DragPay module or any software and/or hardware component specifically related to the claimed invention.

This exemplary embodiment 300 of the claimed invention can be implemented when a Payor that is not registered within the DragPay system is willing to make a payment to a Payee. In this case, the Payor will initiate the transaction process by using a Drag and Drop User Interface operation within the display of the Payee website, using the graphical element corresponding to the DragPay Payee Module 305.

In another embodiment, the Payee website displayed on the Payor Terminal 301 will feature a graphical element that will allow the user to make a payment by using a Drag and Drop user interface within the display area of the Payee website.

This exemplary embodiment 300 of the claimed invention can be implemented for the purpose of general online commerce, for the purpose of payments restricted to micro or small amounts payments, for the purpose of payments via prepaid accounts, for the purpose of donations to individuals and/or organizations, or for any other purpose regarding payments over a network.

This exemplary embodiment 300 of the claimed invention can be implemented for the purpose of micro or small payments, when the payments are eventually received by the Payee once a fixed cumulative amount of Payors payments is reached.

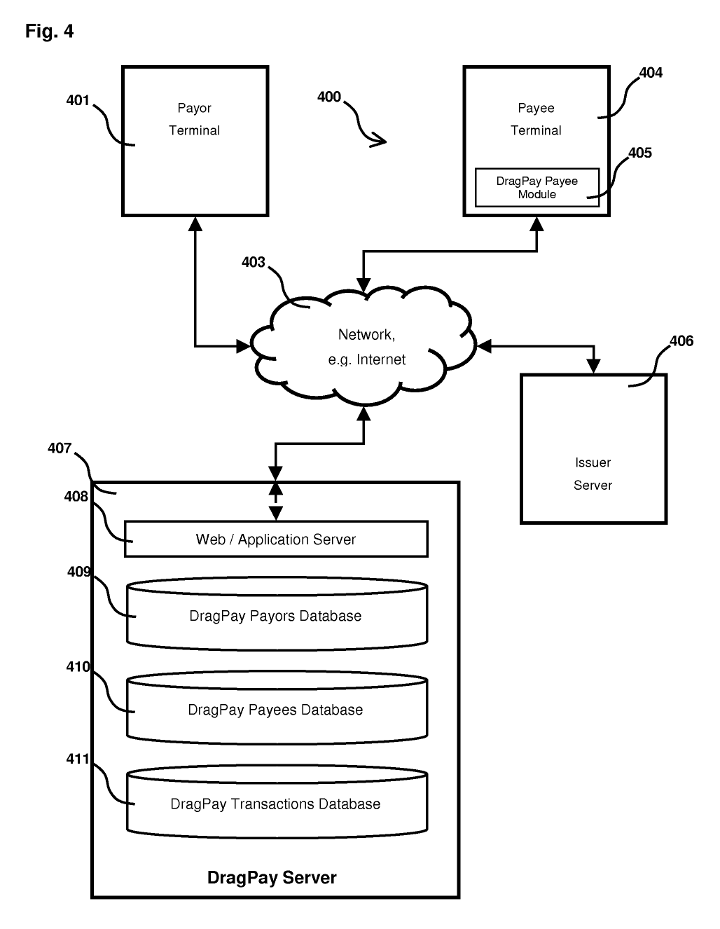

FIG. 4 depicts an overview of the components of an exemplary transaction system 400, with an overview of the components of an exemplary DragPay Server 407.

In this embodiment of the claimed invention, the configuration of the system components 401 (Payor Terminal), 404 (Payee Terminal), 405 (DragPay Payee Module), 403 (Network), 406 (Issuer Server) and 407 (DragPay Server) is similar to the one depicted in FIG. 3, and these components correspond respectively to the components 301, 304, 305, 303, 306 and 307 of FIG. 3. However, the configuration of the components within the DragPay Server 407 described below also applies to the systems configurations depicted in FIG. 1 and FIG. 2.

In this exemplary embodiment of the invention, the DragPay Server 407 comprises a Web/Application Server 408, a DragPay Payors Database 409, a DragPay Payees Database 410, and a DragPay Transactions Database 411.

The Web/Application Server 408 is a hardware and software system that allows the DragPay Server to communicate with the Payor Terminal 401, the Payee Terminal 404, the Issuer Server 406, the other internal components of the DragPay Server 407 and other Terminals and Servers through the Network 403. The Web/Application Server 408 processes incoming queries, information and requests, communicates with the other components of the DragPay Server, and issues outgoing queries, information and requests.

The DragPay Payors Database 409 is a hardware and software database system that manages the information corresponding to the DragPay users registered as Payors.

The DragPay Payees Database 410 is a hardware and software database system that manages the information corresponding to the DragPay users registered as Payees.

The DragPay Transactions Database 411 is a hardware and software database system that manages the information corresponding to the transactions having occurred or pending between Payors and Payees, whereas the corresponding Payees may be registered or not.

An exemplary DragPay Server 407 may comprise a Relational Database Management System that would manage all the information corresponding to the DragPay Payors Database 409, the DragPay Payees Database 410 and the DragPay Transactions Database 411, in a collection of tables and corresponding files; that would manage: (i) all information related to the registered DragPay Payors, such as, and without limitations, User profile and personal information, User Personal Identification Number, User account information, User credit and/or debit and/or issuer account information; (ii) all the information related to the DragPay Payees, such as, and without limitations, Payee profile and personal information, Payee account information, Payee Personal Identification Number, Payee account information; (iii) all the information related to the DragPay transactions, such as, and without limitations, transaction status, transaction Payor and Payee information, transaction date and characteristics.

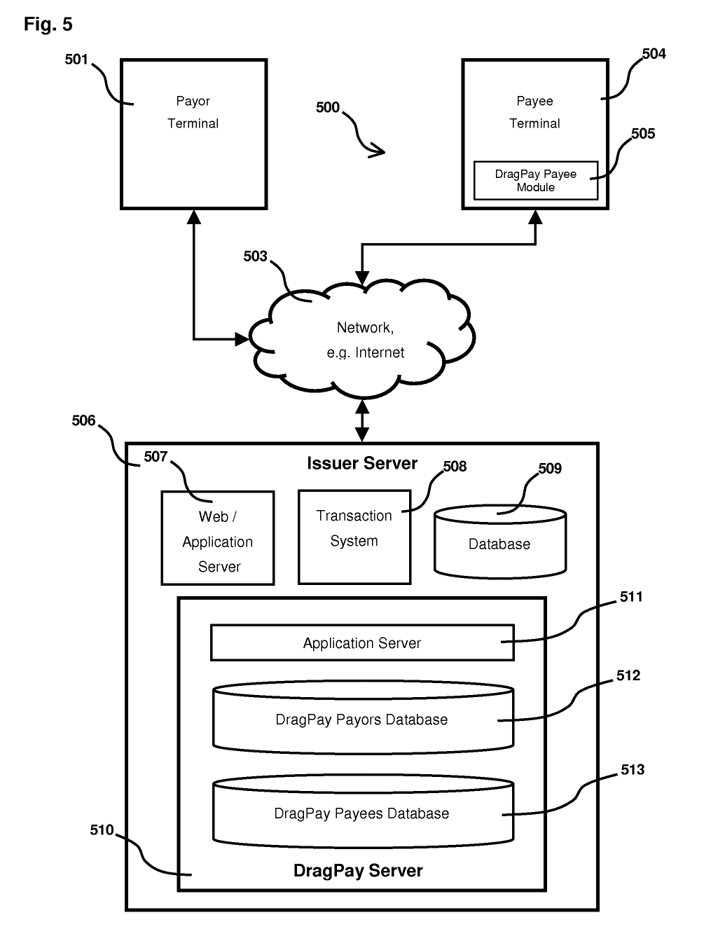

FIG. 5 depicts an overview of the components of an exemplary transaction system 500, with an overview of the components of an exemplary DragPay Server 510 implemented within the Issuer Server 506.

The system 500 represents the configuration of the invention in the case of the invention being implemented by an Issuer institution, or Bank, and the DragPay Server 510 being located within the Issuer institution, or Bank own Server System 506.

In this embodiment of the claimed invention, the configuration of the system components 501 (Payor Terminal), 504 (Payee Terminal), 505 (DragPay Payee Module), 503 (Network), is similar to the one depicted in FIG. 3, and these components correspond respectively to the components 301, 304, 305 and 303 of FIG. 3. However, the configuration of the components within the Issuer Server 505 and the DragPay Server 510 described below also applies to the systems configurations depicted in FIG. 1 and FIG. 2.

In this embodiment of the claimed invention, the Issuer Server comprises a Web/Application Server 507, a Transaction System 508, a Database 509, and the DragPay Server 510.

The Web/Application Server 507 is a hardware and software system that allows the Issuer Server 506 to communicate with the Payor Terminal 501, the Payee Terminal 504, the other internal components of the Issuer Server 506 and other Terminals and Servers through the Network 503. The Web/Application Server 507 processes incoming queries, information and requests, communicates with the other components of the Issuer Server 506, and the components of the DragPay Server 510, and issues outgoing queries, information and requests.

The Transaction System 508 and the associated Database 509 have jointly, and without limitations, the functions of: (i) receiving payment requests from merchant terminal such as a Payee Terminal 504, issued by the Issuer Server 506 or via the Network 503; (ii) transmitting an authorization request to a consumer terminal such as a Payor Terminal 501; (iii) receiving an authorization response from a consumer terminal such as a Payor Terminal 501, (iv) performing credit approval (CAS) procedures, (v) transmitting an authorization confirmation response to a merchant terminal, such as the Payee Terminal 504; as well as other steps such as registering card holders, verifying parties identities and personal information, communicating with the accounts payable system, communicating with the accounts receivable system, billing periodically the Issuer consumers, performing settlements and reconciliations with merchants.

The DragPay Payors Database 512 and the DragPay Payees Database 513 are similar to the components respectively 409 and 410 depicted in FIG. 4

In this embodiment, however, the DragPay Payors Database 512 and the DragPay Payees Database 513 could be managed by the same system as the Issuer Database 509. In particular, a DragPay Transactions Database was not depicted in FIG. 5, as its functions could be included within the Issuer Server 506 as part of the Issuer Transaction System 508 and Database 509.

Any databases discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either automatically or manually. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

One skilled in the art will also appreciate that, for security reasons, any databases, systems, devices, servers or other components of the claimed invention may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible mark-up language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003).

The claimed invention may be described herein in terms of functional block components, optional selections and various processing steps. It should be appreciated that such functional blocks may be realized by any number of hardware and/or software components configured to perform the specified functions. For example, the claimed invention may employ various integrated circuit components, e.g., memory elements, processing elements, logic elements, look-up tables, and the like, which may carry out a variety of functions under the control of one or more microprocessors or other control devices. Similarly, the software elements of the claimed invention may be implemented with any programming or scripting language such as C, C++, Java, COBOL, assembler, PERL, Visual Basic, SQL Stored Procedures, extensible mark-up language (XML), with the various algorithms being implemented with any combination of data structures, objects, processes, routines or other programming elements. Further, it should be noted that the claimed invention may employ any number of conventional techniques for data transmission, signalling, data processing, network control, and the like. Still further, the invention could be used to detect or prevent security issues with a client-side scripting language, such as JavaScript, VBScript or the like.

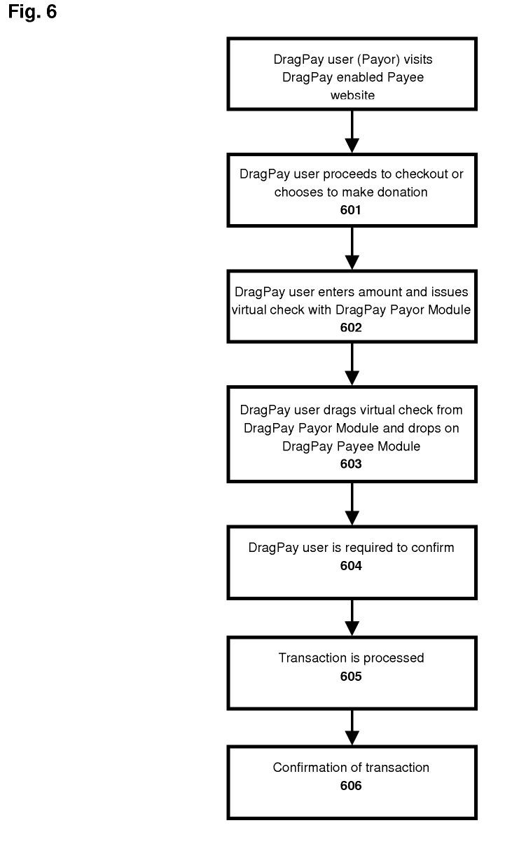

FIG. 6 is a flow diagram that depicts a simplified method implementing one embodiment of the claimed invention corresponding to a system configuration depicted in FIG. 1, that is where the Payor Terminal 101 includes an embedded DragPay Payor Module 102 and the Payee Terminal 104 includes an embedded DragPay Payee Module 105.

This method involves all components depicted in FIG. 1.

As a prior step, a consumer accesses a Payee Terminal 104 over a Network 103 with a Payor Terminal 101, and wishes to issue a payment towards the Payee using the claimed invention. Both the Payor and the Payee are registered within the DragPay Server 106, the Payor can issue payments using an Issuer Server 107, and the Payee can receive payments via an accounts receivable system, not depicted in FIG. 1.

In step 601, the Payor interacts with the Payee system and is willing to make a payment towards the Payee. The Payor is accessing, for instance, and without limitations, a checkout webpage, a donation webpage, or a micropayments webpage, within the Payee system. The Payee website displayed on the Payor Terminal 101 includes a representation of the DragPay Payee Module 105.

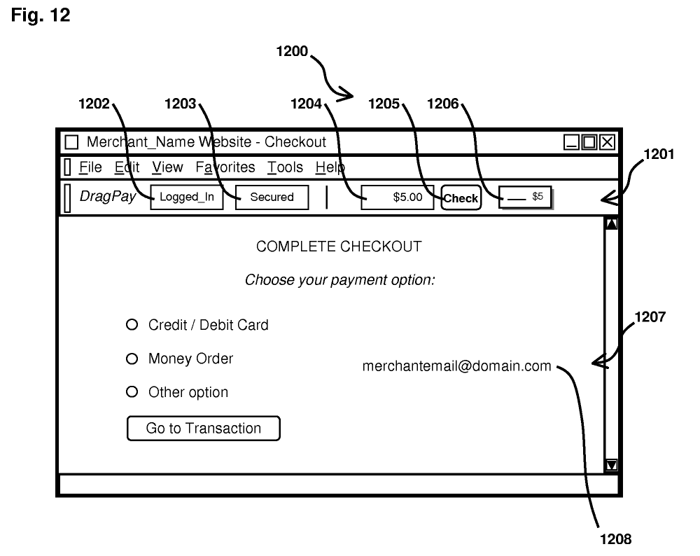

In step 602, the Payor uses the DragPay Payor Module 102 to specify the amount of the payment to be made towards the Payee and enable the payment. In another embodiment of the claimed invention, the DragPay Payor Module 102 is a toolbar, embedded within the browser software used by the Payor Terminal 101 to access the Payee Terminal 104 via the Network 103. In this embodiment, the Payor will enter an amount to be paid within the DragPay toolbar 102 using the Graphical User Interface. An additional step could be issuing a virtual check by confirming the amount entered. This embodiment is depicted as a screenshot in FIG. 12.

In step 603, the Payor uses the Graphical User Interface to drag a graphical element representing the payment from the DragPay Payor Module 102 into the DragPay Payee Module 105 represented on the Payee website. In this embodiment of the DragPay Payor Module 102 being a toolbar embedded within the Payor Terminal 101 browser software, the Payor can drag a virtual check from the DragPay toolbar 102 and drop it on the graphical element, icon or widget displayed on the Payee checkout webpage.

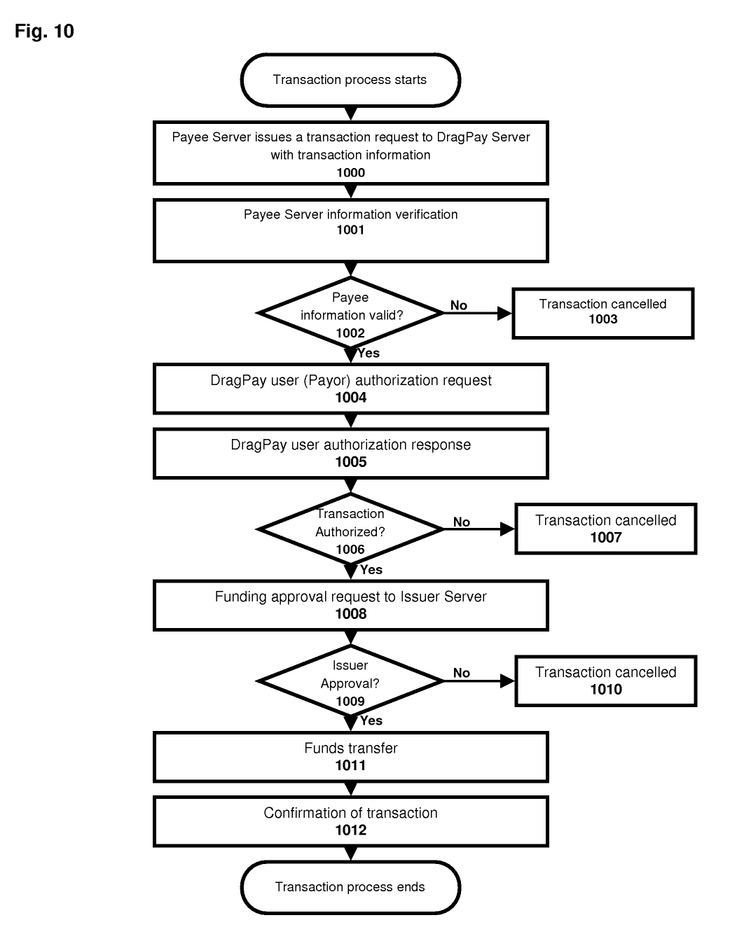

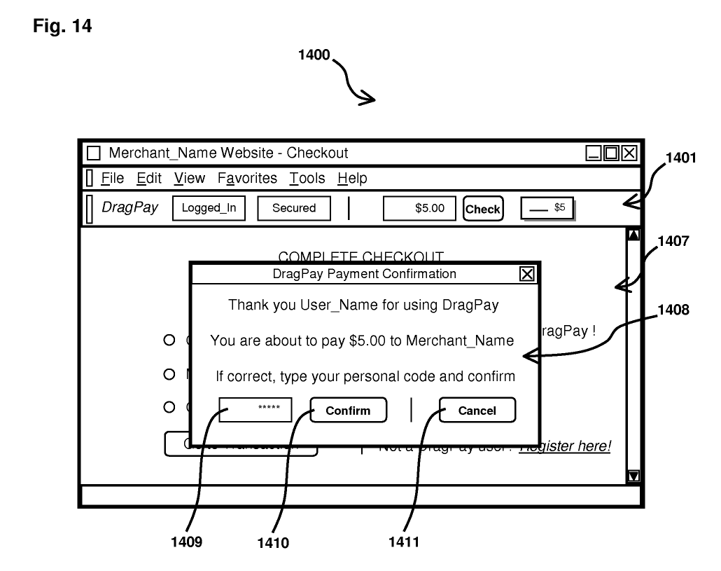

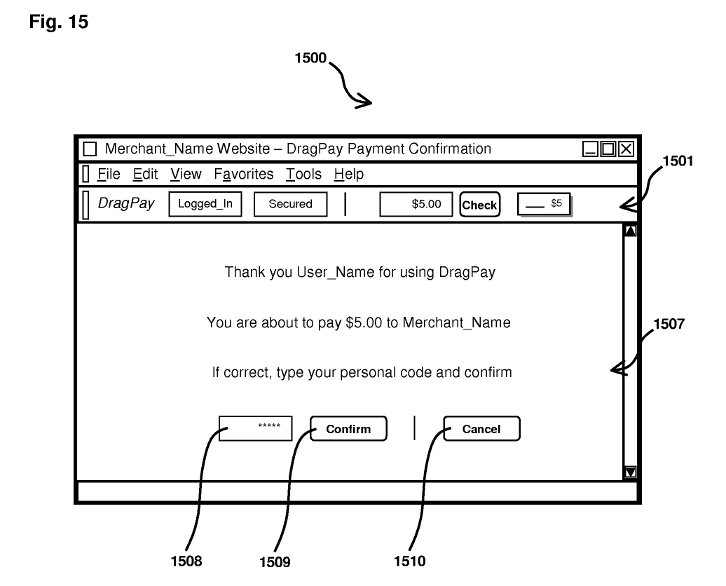

In step 604, the Payor is requested to confirm the information of the transaction about to be processed. This confirmation step 604 can be implemented through a pop up window such as depicted in FIG. 14, or by redirecting the Payor Terminal 101 browser software onto a confirmation webpage coming from the Payee Terminal 104 or the DragPay Server 106, as depicted in FIG. 15. During this Payor confirmation step 604, the Payor may be requested to enter a Personal Identifier Number (PIN), or a personal code, or an Issuer Authorization code, or a CAS (Card Authorization System) related code, to process the transaction, as depicted in both FIG. 14 and FIG. 15. If the Payor confirmation step 604 includes the request of a personal code, then this step 604 can be part of the transaction process itself, as depicted in an exemplary flow chart in FIG. 10, by replacing steps the 1004 and 1005 of requesting the Payor authorization to process the transaction.

In step 605, the payment transaction is processed, involving the Payee Terminal 104, the DragPay Server 106, the Issuer Server 107, and the Payee account receivable system. An exemplary method for such transaction is depicted in FIG. 10.

Once the transaction has been processed, the method includes a confirmation step 606, in which the DragPay Server sends out notice to both the Payor Terminal 101 and the Payee Terminal 104, with, for instance, and without limitations, emails, text messages to GSM devices, Instant Messaging messages, or XML documents.

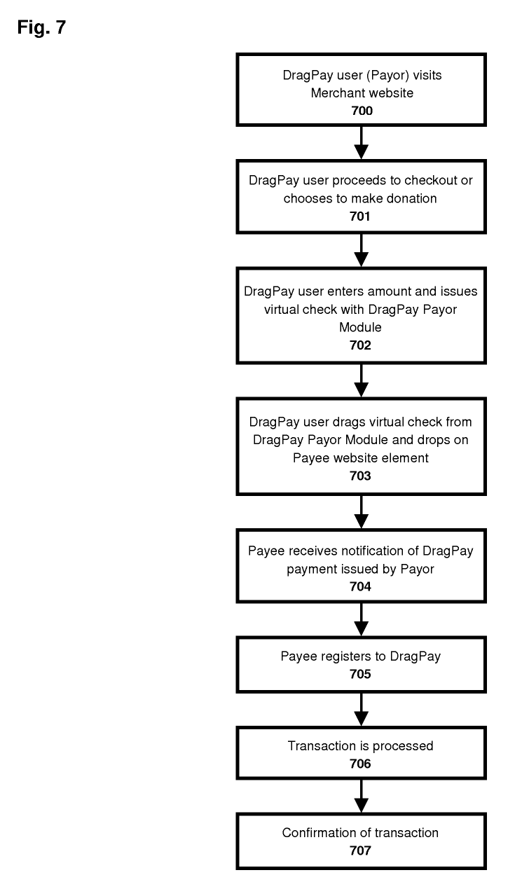

FIG. 7 is a flow diagram that depicts a simplified method implementing one embodiment of the claimed invention corresponding to a system configuration depicted in FIG. 2, that is where the Payor Terminal 201 includes an embedded DragPay Payor Module 202 and the Payee Terminal 204 does not include an embedded DragPay Payee Module.

This method involves all components depicted in FIG. 2.

As a prior step, a consumer accesses a Payee Terminal 204 over a Network 203 with a Payor Terminal 201, and wishes to issue a payment towards the Payee using the claimed invention. In this embodiment, only the Payor needs to be registered within the DragPay Server 206, and the Payor can issue payments using an Issuer Server 207.

Steps 701 and 702 are similar respectively to steps 601 and 602 of FIG. 6.

In step 703, the Payor uses the Graphical User Interface to drag a graphical element representing the payment from the DragPay Payor Module 202 into an element displayed on the Payee website. In this embodiment of the DragPay Payor Module 202 being a toolbar embedded within the Payor Terminal 201 browser software, the Payor can drag a virtual check from the DragPay toolbar 202 and drop it on a graphical component displayed on the Payee webpage. This embodiment is depicted as a screenshot in FIG. 12. Such a component can be, without limitations, an email address, an URL, or the whole display of the Payee website. When the Payor has performed the drag and drop operation, its characteristics are sent as a request to the DragPay Server 206.

The DragPay Server 206 will associate the Payee with an identifier, such as, and without limitations, an email, a full name, an URL, a IP address, a MAC address, or any combination of such information, and will send to the Payee in step 704 a notification of the payment request issued by the Payor. Such notification can be issued as an email, a text message to a GSM device, an Instant Messaging message, or an XML document.

If the Payee is registered with the DragPay Server 206, including the information necessary to process a payment through the Payee account receivable system, then the registration step 705 can be skipped and the transaction can be processed though step 706.

If the Payee is not registered with the DragPay Server 206, then the payment notification will include a method with which the Payee can register in step 705 with the DragPay Server 206 and receive payment via the Payee account receivable system.

The actual transaction processing step 706 and its confirmation step 707 are similar to steps 605 and 606 respectively of FIG. 6. FIG. 10 depicts an exemplary method for the transaction process step 706. FIG. 14 and FIG. 15 depict, as screenshots, possible implementations of confirmation step 707.

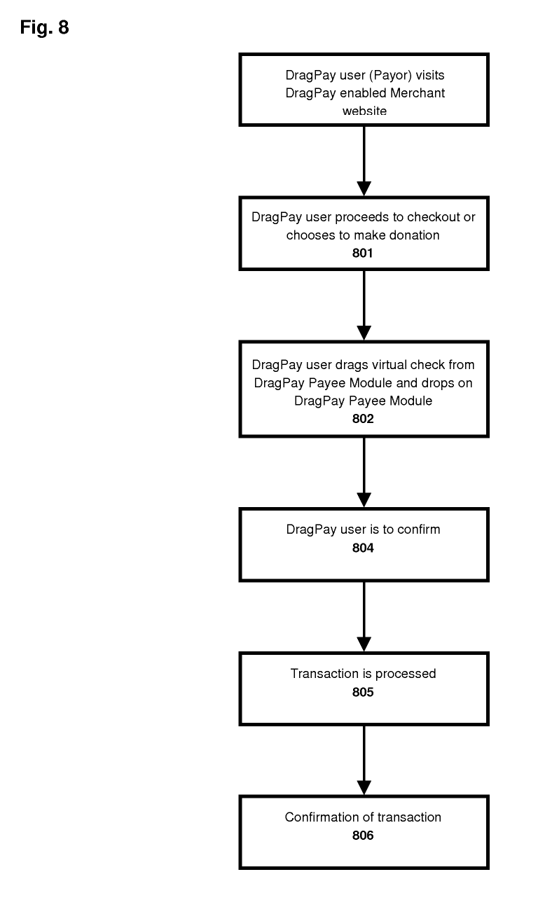

FIG. 8 is a flow diagram that depicts a simplified method implementing one embodiment of the claimed invention corresponding to a system configuration depicted in FIG. 3, that is where the Payor Terminal 301 does not include an embedded DragPay Payor Module and the Payee Terminal 304 includes an embedded DragPay Payee Module 305.

The method involves all components depicted in FIG. 3.

As a prior step, a consumer accesses a Payee Terminal 304 over a Network 303 with a Payor Terminal 301, and wishes to issue a payment towards the Payee using the claimed invention. In this embodiment, only the Payee needs to be registered within the DragPay Server 306, the Payor can issue payments using an Issuer Server 307, and the Payee can receive payments via an accounts receivable system, not depicted in FIG. 3.

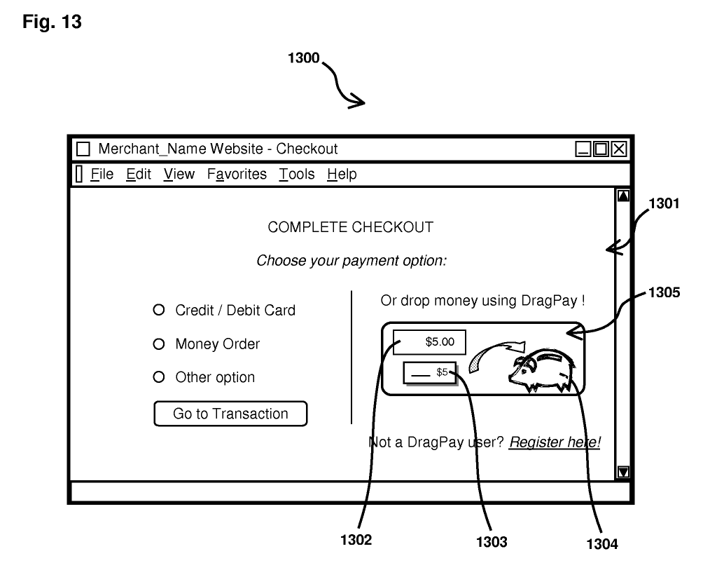

In step 801, the Payor interacts with the Payee system and is willing to make a payment towards the Payee. The Payor is accessing, for instance, and without limitations, a checkout webpage, a donation webpage, or a micropayment webpage, within the Payee system. The Payee website displayed on the Payor Terminal 301 includes a representation of the DragPay Payee Module 305. In another embodiment of the claimed invention, depicted as a screenshot in FIG. 13, the DragPay Payee Module 305 is displayed as a widget on the Payee checkout webpage.

In step 802, the Payor interacts with the DragPay Payee Module 305 displayed on the Payee webpage to issue a payment, by dragging a graphical element from the DragPay Payee Module 305 and dropping it onto another graphical element displayed on the DragPay Payee Module 305. FIG. 13 depicts an exemplary embodiment of this method, in which the Payor drags a virtual check 1303 and drops it into a graphical element 1304 within a widget 1305 representing the DragPay Payee Module 305. In this embodiment, the Payor can also specify an amount of money to be paid using this method, using a control box 1302 within the DragPay Payee Module 305.

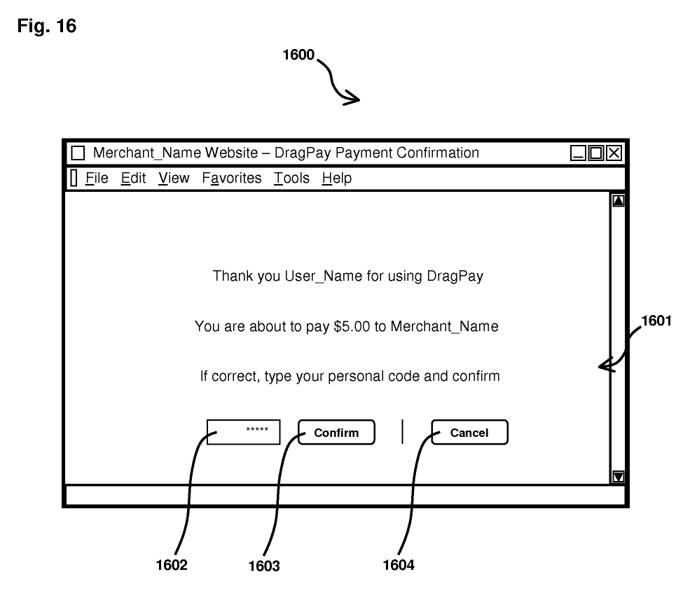

In step 803, the Payor is requested to confirm the information of the transaction about to be processed. This confirmation step 803 can be implemented through by redirecting the Payor Terminal 301 browser software onto a confirmation webpage coming from the Payee Terminal 304 or the DragPay Server 306, as depicted as a screenshot in FIG. 16. During this confirmation step 803, the Payor may be requested to enter a Personal Identifier Number (PIN), or a personal code, or a CAS related code, to process the transaction, as depicted in FIG. 16.

The actual transaction processing step 804 and its confirmation step 805 are similar to steps 605 and 606 respectively of FIG. 6. FIG. 10 depicts an exemplary method for the transaction process step 804. FIG. 16 depicts, as a screenshot, a possible implementation of confirmation step 805.

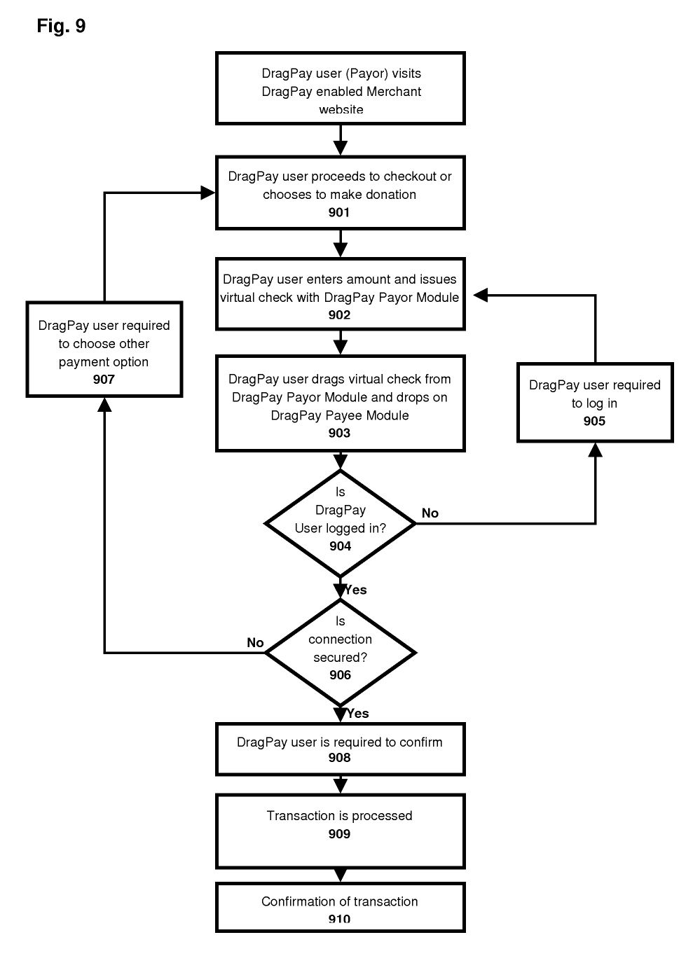

FIG. 9 is a flow diagram that depicts a method implementing one embodiment of the claimed invention corresponding to a system configuration depicted in FIG. 1, that is where the Payor Terminal 101 includes an embedded DragPay Payor Module 102 and the Payee Terminal 104 includes an embedded DragPay Payee Module 105. The method depicted in FIG. 9 is a variation of the method depicted in FIG. 6, adding optional steps aimed at guaranteeing the security of the transaction.

This method involves all components depicted in FIG. 1.

As a prior step, a consumer accesses a Payee Terminal 104 over a Network 103 with a Payor Terminal 101, and wishes to issue a payment towards the Payee using the claimed invention. Both the Payor and the Payee are registered within the DragPay Server 106, the Payor can issue payments using an Issuer Server 107, and the Payee can receive payments via an accounts receivable system, not depicted in FIG. 1.

Steps 901, 902 and 903 are similar to steps 601, 602 and 603 respectively in FIG. 6.

In step 904, the DragPay Payor Module 102 verifies that the Payor is logged in to verify that the identity of the person accessing the Payee Terminal 104 with the Payor Terminal 101. Being logged in usually requires to have entered a personal identifier code, or login, and a corresponding password. This additional step is relevant when multiple individuals can have access to the Payor Terminal 101.

If the Payor is not logged in within the DragPay Payor Module 102, then it is required to do so in step 905, and then is redirected to step 902 where the Payor can use the DragPay Payor Module 102 to initiate a payment by entering or selecting an amount to be paid.

If the Payor was already logged in during step 904, then in step 906 the DragPay Payor Module verifies that the connections over the Network 103 between (a) the Payor Terminal 101, and (b) the Payee Terminal 104 and/or the DragPay Server 106, are secured. One exemplary way of checking the security status of such connections is to verify that the terminals are communicating using a HTTPS or Secure Hypertext Transfer Protocol. Any other security or encryption protocol or layer can be used for the purpose of step 906.

If during step 906, the DragPay Payor Module detects that the connections do not fulfil the security requirements, then the DragPay payment procedure is not permitted, and the Payor is asked in step 907 to choose from the other payment methods to make its payment or donation.

If during step 906, the DragPay Payor Module detects that the connections fulfil the security requirements, then the transaction is initiated in step 908.

Steps 908, 909 and 910 are similar to steps 604, 605 and 606 respectively in FIG. 6.

The purpose of FIG. 9 is to depict an embodiment of added security layers to the simplified exemplary method depicted in FIG. 6, as security is a primary concern in transactions processed over a network.

The same security layers (steps 904, 905, 906 and 907) can also be implemented within the simplified methods depicted in FIG. 7 and FIG. 8, that is for any embodiment of the claimed invention, whether the Payor Terminal includes a DragPay Payor Module, and whether the Payee Terminal includes a DragPay Payee Module.

In addition, the additional steps 904 and 905 on one hand, and 906 and 907 on the other hand, can be implemented at different steps within the overall method. For instance, in a different embodiment, the steps 904 and 905 can be implemented before step 902, so that the Payor Terminal 101 user can only interact with the DragPay User Module 102 if he has previously logged in and/or has already been authenticated.

FIG. 10 is a flow chart depicting an exemplary transaction process that will follow the methods of the claimed invention as depicted in the exemplary embodiments of FIG. 6, FIG. 7, FIG. 8 and FIG. 9.

Transactions happening over a network or the Internet is a topic that is largely covered by relevant literature, the purpose of FIG. 10 is to propose an embodiment of such transaction to be implemented within the system of the claimed invention, but is not intended to limit the claimed invention to its particular transaction process, as it is not the chore of the novelty of the claimed invention.

The exemplary transaction process begins after interaction between the Payor Terminal 101, 201 or 301 and the Payee Terminal 104, 204 or 304 results in an agreed upon payment from the Payor to the Payee.

In step 1000, the Payee Terminal or system (104, 204, or 304 in respectively FIG. 1, 2 or 3) issues a transaction request to the DragPay Server (106, 206 or 306 in respectively FIG. 1, 2, or 3) through the Network (103, 203 or 303 in respectively FIG. 1, 2 or 3). The transaction request includes information relative to the identification of the Payee, to the identification of the Payor, and to the transaction itself, such, as and without limitations, the amount of the transaction, a label or string of text or identification number corresponding to the underlying purpose of the transaction (e.g. item purchased, Payor comment, URL of a personal page accepting donations, a micropayment collecting identification number or string), a transaction request identification number, the date and time at which the transaction is scheduled.

In step 1001, the DragPay Server (106, 206 or 306 in respectively FIG. 1, 2 or 3) will verify the information received from the Payee Terminal (104, 204, or 304 in respectively FIG. 1, 2, or 3). This verification process includes, and without limitations, verification of the Payee identification information, verification that the underlying purpose of the transaction is registered as valid, verification of the IP address and/or MAC address and/or URL of the Payee Terminal, verification that the amount of the transaction is permitted by the system (for instance in the case of micropayments), verification of the Payor identification information.

In step 1002, if the transaction information issued by the Payee Terminal (104, 204, or 304 in respectively FIG. 1, 2, or 3) is not valid for whatever reason, then the transaction is cancelled in step 1003. When a transaction is cancelled, a message is usually sent to both the Payor and the Payee explaining why the transaction was aborted, as an email, a webpage, a database entry or in any other traceable way, and the DragPay Server keeps the information in a log or dedicated database such as the databases 411 and 509 depicted respectively in FIGS. 4 and 5.

It will be apparent to those skilled in the art that other embodiments of the claimed invention can have the transaction issued by the Payor Terminal (101, 102 or 103), instead of the Payee Terminal (104, 204 or 304), sending the same information described therein through the Network (103, 203 or 303). Steps 1000, 1001, 1002 and 1003 would then be adapted to take this into account.

In step 1002, if the transaction information issued by the Payee Terminal (104, 204, or 304 in respectively FIG. 1, 2, or 3) is valid, then the DragPay Server (106, 206 or 306 in respectively FIG. 1, 2 or 3) will issue an authorization request to the Payor Terminal (101, 201 or 301 in respectively FIG. 1, 2 or 3).

The Payor authorization request can be sent directly from the DragPay Server to the Payor Terminal, or indirectly via the Issuer Server (107, 207 or 307 in respectively FIG. 1, 2 or 3). In an exemplary embodiment of the claimed invention, the Payor has registered within the DragPay Server the information relative to a credit or debit card, and in step 1002 the DragPay Server will communicate with the Issuer Server so that the corresponding Issuer Server will send the authorization request to the Payor Terminal.

In step 1003, the Payor will respond to the authorization request received on the Payor Terminal (101, 201 or 301 in respectively FIG. 1, 2 or 3). The response can be a personal code specific to the DragPay Server, or a CAS (Card Authorization System) code specific to the Issuer Server authorization system, or any other identity verification mean. Practitioners will appreciate that verification of identity can be accomplished by a variety of means, including cad holder ID and password, PIN number, SIM card in cellular phones, voice recognition system, any other biometric measurement system, or by swiping a physical smart card in the case of a point of sale situation.

As specified above, the Payor confirmation step depicted as steps 604, 704, 804 and 908 in respectively FIGS. 6, 7, 8 and 9 can include a Payor authorization sequence by requesting an identification code. In the case of such embodiments, Payor authorization steps 1002 and 1003 can replace or can be replaced by step 604, 704, 804 or 908 in respectively FIG. 6, 7, 8 or 9, as they will be redundant.

In addition, the Payor authentication steps 1002 and 1003 may serve both to authenticate the identity of the consumer and to authorize the payment to the Payee.

In step 1006, the DragPay Server (106, 206 or 306 in respectively FIG. 1, 2 or 3) or the Issuer Server (107, 207 or 307 in respectively FIG. 1, 2 or 3) will analyze the Payor authorization response.

If the authorization information supplied by the Payor is not valid, then the transaction is cancelled in step 1007, and the corresponding information is sent to the Payor Terminal and the Payee Terminal, and stored in the DragPay Server and/or the Issuer Server.

If the authorization information supplied by the Payor is valid, then the DragPay Server (106, 206 or 306 in respectively FIG. 1, 2 or 3) will issue a Funding Approval Request to the Issuer Server (107, 207 or 307 in respectively FIG. 1, 2 or 3) in step 1008. In one embodiment, this additional step verifies that the Payor has sufficient credit within its Issuer institution accounts to process the transaction.

If the Issuer Server issues a negative response to the Funding Approval Request, then the transaction is cancelled in step 1010, and the corresponding information is sent to the Payor Terminal and the Payee Terminal, and stored in the DragPay Server and/or the Issuer Server.

If the Issuer Server approves the Funding Approval Request, then funds are transferred in step 1011 from the Payor account to the Payee receivable system account.

In the case of an embodiment of the claimed invention for the purpose of micropayments or other small amounts, for instance for donations to freeware programmers, personal webpages, non-profit organizations, then the transfer of funds may be delayed until a sufficient cumulative amount of payments from multiple Payors is reached, in order to reduce transaction costs.

In step 1012, the transaction is confirmed by the DragPay Server, which issues confirmation messages to the Payor Terminal, the Payee Terminal, the Issuer Server, and stores the corresponding information in its database system. Such messages can be issued through XML documents, database entries, email messages, GSM text messages, regular mail messages, fax, or any other traceable way.

The step 1012 corresponds and is equivalent to steps 606, 707, 806 and 910 in respectively FIG. 6, FIG. 7, FIG. 8 and FIG. 9.

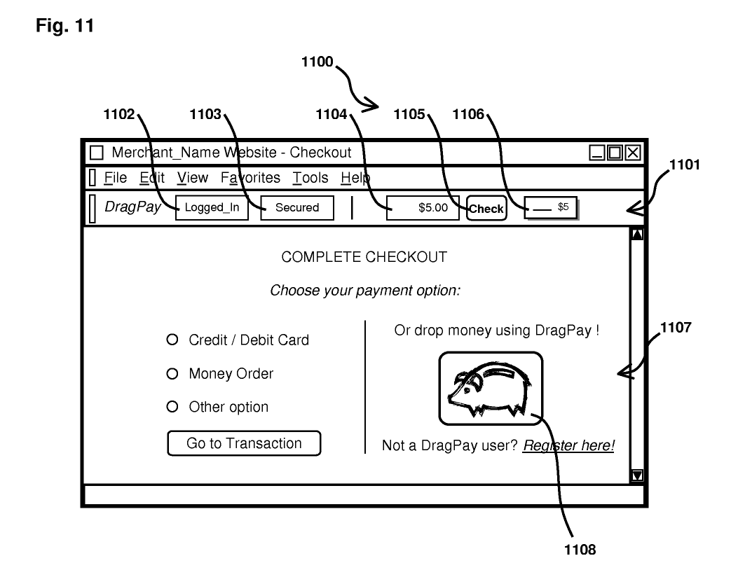

FIG. 11 shows a screenshot of an exemplary embodiment of the claimed invention corresponding to the configuration of FIG. 1, that is when the Payor Terminal 101 includes a DragPay Payor Module 102, and the Payee Terminal 104 includes a DragPay Payee Module 105.

The screenshot represents a Payee checkout or payment window 1100, accessed by the Payor Terminal 101 through the Network 103 and displayed in a browser software. The Payor Terminal 101 may be a personal computer, a connected PDA or cellular phone or smart phone, or any other connected terminal that features a Graphical User Interfaces that includes a Pointing Device.

The situation depicted by the screenshot 1100 happens after a Payor accesses a Payee Terminal 104 over a Network 103 with a Payor Terminal 101, and wishes to issue a payment towards the Payee using the claimed invention. In this embodiment, the DragPay Payor Module 102 is represented by a toolbar 1101 embedded within the Payor Terminal 101 browser software interface.

In this particular embodiment of the claimed invention, the toolbar interface displays a collection of features, each of them being optional for the implementation of the claimed invention.

The graphical element 1102 is a display or control that informs the Payor Terminal user if a Payor is logged in within the DragPay Payor Module, and can additionally display the identity or login of the logged in user.

The graphical element 1103 is a display or control that informs the Payor Terminal user if there is a connection between the Payor Terminal 101 and the Payee Terminal 104 and/or DragPay Server 106 and/or Issuer Server 107.

The graphical elements 1102 and 1103 are visual displays that allow the user to anticipate the automated verifications steps that can be implemented for security reasons, such as steps 904 and 905 depicted in FIG. 9.

The graphical element 1104 is a control box that allows the Payor Terminal user to enter an amount to be paid to the Payee. The graphical element, 1105 for example a button, when activated, creates a graphical element 1106, which is an icon or image that represents a virtual check of the amount entered in the control box 1104.

In this particular embodiment, the step 602 of FIG. 6 corresponds to the user typing in the control box 1104 an amount to be paid, then clicking on the button 1105 in order to issue a virtual check 1106.

In this particular embodiment, the Payee payment or checkout webpage 1107 allows the Payor to make a payment through different options displayed, each requiring additional steps, or to make a payment using the claimed invention, referred as DragPay. The DragPay Payee Module is displayed by an active component or widget 1108 on the Payee payment or checkout webpage 1107.

In step 603 in FIG. 6, the Payor drags and drops the virtual check 1106 onto the DragPay Payee Module component 1108, by:
clicking or tapping with the Pointing Device on the virtual check 1106, then, while holding the Pointing Device activated (for instance, holding the mouse button down, or holding pressure on the touchpad or touchscreen),
by moving the cursor (for instance mouse cursor) or pointer (for instance finger or stylus) from the virtual check 1106 until it is above the DragPay Payee Module component 1108, and then
by releasing the Pointing Device (for instance, releasing the previously held mouse button, or releasing the finger or stylus from the touchpad or touchscreen).

FIG. 12 shows a screenshot of an exemplary embodiment of the claimed invention corresponding to the configuration of FIG. 2, that is when the Payor Terminal 201 includes a DragPay Payor Module 202, and the Payee Terminal 204 does not include a DragPay Payee Module.

The screenshot represents a Payee checkout or payment window 1200, accessed by the Payor Terminal 201 through the Network 203 and displayed in a browser software. The Payor Terminal 201 may be a personal computer, a connected PDA or cellular phone or smart phone, or any other connected terminal that features a Graphical User Interfaces.

The situation depicted by the screenshot 1200 happens after a Payor accesses a Payee Terminal 204 over a Network 203 with a Payor Terminal 201, and wishes to issue a payment towards the Payee using the claimed invention. In this particular embodiment, the DragPay Payor Module 202 is represented by a toolbar 1201 embedded within the Payor Terminal 201 browser software interface.

The features represented by the graphical elements 1202, 1203, 1204, 1205 and 1206 within the toolbar 1201 are similar to the elements 1102, 1103, 1104, 1105 and 1106 in the toolbar 1101 depicted in FIG. 11.

In this particular embodiment, the step 702 of FIG. 7 corresponds to the user typing in the control box 1204 an amount to be paid, then clicking on the button 1205 in order to issue a virtual check 1206.

In this embodiment, the step 703 of FIG. 7 corresponds to the Payor dragging and dropping the virtual check 1206 onto a component of the Payee website 1207, such, as, and without limitations, an email address 1208, the webpage 1207 itself, the URL of the website, or any other element that can be linked to an individual or company identity.

In addition, in an embodiment of the claimed invention corresponding to the configuration of FIG. 2 (the Payee Terminal 204 does not include a DragPay Payee Module), the Payor can make a payment using the claimed invention by dragging and dropping the virtual check 1206 on a component displayed on any webpage part of the Payee website; and is not restricted to dragging and dropping within the Payee checkout or payment page 1207.

FIG. 13 shows a screenshot of an exemplary embodiment of the claimed invention corresponding to the configuration of FIG. 3, that is when the Payor Terminal 301 does not include a DragPay Payor Module, and the Payee Terminal 304 includes a DragPay Payee Module 305.

The screenshot represents a Payee checkout or payment window 1300, accessed by the Payor Terminal 301 through the Network 303 and displayed in a browser software. The Payor Terminal 301 may be a personal computer, a connected PDA or cellular phone or smart phone, or any other connected terminal that features a Graphical User Interfaces.

The situation depicted by the screenshot 1300 happens after a Payor accesses a Payee Terminal 304 over a Network 303 with a Payor Terminal 301, and wishes to issue a payment towards the Payee using the claimed invention.

In this embodiment, the Payee payment or checkout webpage 1301 allows the Payor to make a payment through different options displayed, each requiring additional steps, or to make a payment using the claimed invention, referred as DragPay in the screenshot. The DragPay Payee Module is displayed by an active component or widget 1305 on the Payee payment or checkout webpage 1301.

In this particular embodiment, the DragPay Payee Module 305 component 1305 includes three features:
a control box 1302 that allows the Payor to enter an amount of money to be paid,
a graphical component 1303 that represents a virtual check of the amount entered in the control box 1302, and
a graphical component 1304 that allows payment to be collected by dropping.

The control box 1302 is optional for this embodiment, as the amount to be paid could be part of the following Payor confirmation step. In addition, in the case of micropayments, or small payments, the amount to be paid could be fixed beforehand.

In this particular embodiment of the invention, the step 802 of FIG. 8 corresponds to the Payor interacting with the DragPay Payee Module component 1305, by dragging and dropping the virtual check 1303 onto the graphical element 1304.

FIG. 14 shows a screenshot 1400 of a confirmation window 1408 for an exemplary embodiment corresponding to the configurations of either FIG. 1 or FIG. 2, that is when the Payor Terminal 101 or 201 includes a DragPay Payor Module 102 or 202, represented as a toolbar 1401.

The toolbar 1401 includes the same features of the toolbars 1101 and 1201 represented in respectively the screenshots 1100 and 1200 of FIG. 11 and FIG. 12.

After the Payor has initiated a payment using the claimed invention by dragging and dropping (steps 603 and 703 in respectively FIGS. 6 and 7), the Payor is requested to confirm the information of the transaction about to be processed.

In this exemplary embodiment, the confirmation step is occurring in a pop up window 1408 that is opened by the DragPay Payor Module 102 or 202.

The confirmation window includes a control box 1409 that allows the user to enter its personal code or personal identifier number to confirm the transaction, a confirm graphical user interface, such as a button, 1410 that initiates the transaction process if the personal code or personal identifier number provided is valid, and a cancel graphical user interface, such as a button, 1411 that cancels the transaction and closes the confirmation window 1408.

This preferred embodiment includes the request of a code to process the transaction, however the claimed invention could be embodied without this step, or with any other identification and confirmation method.

The screenshot 1400 and the confirmation window 1408 correspond to the steps 604 and 704 in respectively FIG. 6 and FIG. 7.

FIG. 15 shows a screenshot 1500 of a confirmation webpage 1507 for an exemplary embodiment corresponding to the configurations of either FIG. 1 or FIG. 2, that is when the Payor Terminal 101 or 201 includes a DragPay Payor Module 102 or 202, represented as a toolbar 1501.

The toolbar 1501 includes the same features of the toolbars 1101 and 1201 represented in respectively the screenshots 1100 and 1200 of FIG. 11 and FIG. 12.

After the Payor has initiated a payment using the claimed invention by dragging and dropping (steps 603 and 703 in respectively FIGS. 6 and 7), the Payor is requested to confirm the information of the transaction about to be processed.

In this exemplary embodiment, the confirmation step is occurring in a webpage 1507 on which the Payor Terminal 101 or 201 browser software is redirected. The confirmation webpage can be hosted either by the Payee Terminal 104 or 204, or the DragPay Server 106 or 206, or the Issuer Server 107 or 207.

The confirmation webpage includes a control box 1508 that allows the user to enter its personal code or personal identifier number to confirm the transaction, a confirm graphical user interface, such as a button, 1509 that initiates the transaction process if the personal code or personal identifier number provided is valid, and a Cancel graphical user interface, such as a button, 1510 that cancels the transaction and redirects the Payor Terminal browser software to another webpage, such as the precious checkout or payment webpage, or the Payee Terminal root or home webpage. This exemplary embodiment includes the request of a code to process the transaction, however the claimed invention could be embodied without this step, or with any other identification and confirmation method.

The screenshot 1500 and the confirmation webpage 1507 correspond to the steps 604 and 704 in respectively FIG. 6 and FIG. 7.

FIG. 16 shows a screenshot 1600 of a confirmation webpage 1601 for an exemplary embodiment corresponding to the configurations of FIG. 3, that is when the Payor Terminal 301 does not include a DragPay Payor Module.

After the Payor has initiated a payment using the claimed invention by dragging and dropping (step 803 in FIG. 8), the Payor is requested to confirm the information of the transaction about to be processed.

In this exemplary embodiment, the confirmation step is occurring in a webpage 1601 on which the Payor Terminal 301 browser software is redirected. The confirmation webpage can be hosted either by the Payee Terminal 304, or the DragPay Server 306, or the Issuer Server 307.

The confirmation webpage includes a control box 1602 that allows the user to enter its personal code or personal identifier number to confirm the transaction, a confirm graphical user interface, such as a button, graphical user interface, such as a button, 1603 that initiates the transaction process if the personal code or personal identifier number provided is valid, and a Cancel button 1604 that cancels the transaction and redirects the Payor Terminal browser software to another webpage, such as the precious checkout or payment webpage, or the Payee Terminal root or home webpage. This exemplary embodiment includes the request of a code to process the transaction, however the claimed invention could be embodied without this step, or with any other identification and confirmation method.

The screenshot 1600 and the confirmation webpage 1601 correspond to the step 804 in FIG. 8.

It will be apparent to those skilled in the art that various modifications and variations can be made in the method and system of the claimed invention without departing from the spirit or scope of the invention. Thus, it is intended that the claimed invention include modifications and variations that are within the scope of the appended claims and their equivalents.

What is claimed is:

1. A method for enabling an online payment between a Payor using a computer readable medium, including a display, a user input device and a connection to a Network, having a server, and a Payee with a means for receiving the payment, the method comprising the steps of:
displaying on the Payor display a first graphical user interface element adapted to be dragged; and
displaying on the Payor display a second graphical user interface element in a website; and
selecting, in response to the Payor user input device, the first graphical user interface element; and
dragging, in response to the Payor user input device, the first graphical user interface element; and
dropping the first graphical user interface element, in response to the Payor user input device, onto the second graphical user interface element; and
sending, in response to the drag and drop interaction, information identifying the Payor and the Payee and specifying an amount of the transaction to a processor having a transaction manager in order to initiate a transaction.

2. The method of claim 1, wherein the online payment is a donation.

3. The method of claim 1, wherein the Payor uses a prepaid account to make the payment.

4. The method of claim 1, wherein the amounts of the payments are limited to a specific value.

5. The method of claim 1, wherein the method is used for micropayments, or small payments.

6. The method of claim 1, wherein the first graphical user interface element is displayed on the user interface of a computer module embedded into the computer readable medium of the Payor.

7. The method of claim 1, wherein the first graphical user interface element is displayed on a Payee website.

8. The method of claim 1, wherein the second graphical user interface element is part of a computer module or connected with a Payee website and system.

9. The method of claim 1, wherein the second graphical user interface element is a part of a Payee website, such as an email address, a URL, or a webpage.

10. The method of claim 6, comprising of a means of specifying, in response to the user input device, the amount of the payment using the user interface of the computer module embedded into the computer readable medium of the Payor.

11. The method of claim 6, wherein the payment can only be made if the connection between the computer readable medium of the Payor and a Payee website is secured.

12. The method of claim 7, further comprising the further step of specifying on the Payee website, in response to the user input device, the amount of the payment.

13. The method of claim 7, wherein the payment can only be made if the connection between the computer readable medium of the Payor and a Payee website is secured.

14. The method of claim 1, wherein the Payor uses a prepaid account, funded by a gift card or other prepaid account with other entities.
